(19) United States
(12) Patent Application Publication
(10) Pub. No.: US 2009/0295760 A1
(43) Pub. Date: Dec. 3, 2009

(54) TOUCH SCREEN DISPLAY

(75) Inventors: Anders Carl Sigfrid LINGE, Kavlinge (SE); Carl Martin Olof EK, Dalby (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/191,627

(22) Filed: Aug. 14, 2008

Related U.S. Application Data
(60) Provisional application No. 61/057,953, filed on Jun. 2, 2008.

(51) Int. Cl. G06F 3/033

(52) U.S. Cl. 345/179

(57) ABSTRACT

A device may include a display and at least one electromagnetic radiation source configured to emit electromagnetic radiation not visible to a user through an upper surface of the display. The device may also include a number of sensors configured to detect electromagnetic radiation that is reflected from the user's finger or a stylus contacting the upper surface of the display. The device may further include logic configured to receive an indication from at least one of the plurality of sensors that a contact was detected and process the contact.

### RELATED APPLICATION

This application claims priority under 35 U.S.C. § 119 based on U.S. Provisional Application No. 61/057,953, filed Jun. 2, 2008, the disclosure of which is hereby incorporated herein by reference.

### TECHNICAL FIELD OF THE INVENTION

The invention relates generally to displays and, more particularly, to touch screen displays.

### DESCRIPTION OF RELATED ART

Currently, most touch screens used in electronic devices are resistive touch screens. Resistive touch screens may be applied to many types of displays and are relatively inexpensive. A drawback with resistive touch screens is that the resistive touch screen is applied to the front of the display. This reduces the front-of-screen performance since the resistive touch screen components/layers are placed in front of the display. These added components/layers reduce the brightness of the display.

Other types of touch screens use sensors in an attempt to detect light from the display which is reflected from a user's finger placed on the surface of the display and register an input based on the detected light. A drawback with these types of touch screens is that light reflected from the user's finger and detected by the sensor is content dependent. As a result, in situations where a dark image is displayed on the touch screen, the reflected light will be extremely weak and may not be detected by the sensor.

### SUMMARY

According to one aspect, a device is provided. The device includes a display and at least one electromagnetic radiation source configured to emit electromagnetic radiation that is not visible to a user through an upper surface of the display. The device also includes a plurality of sensors configured to detect at least a portion of the emitted electromagnetic radiation that is reflected from the user's finger or a stylus contacting the upper surface of the display. The device further includes logic configured to receive an indication from at least one of the plurality of sensors that a contact was detected and process the contact.

Additionally, the logic may be further configured to determine a location on the display or a display element associated with the contact and process the contact based on the location or display element.

Additionally, the at least one electromagnetic radiation source comprises a plurality of infrared radiation emitting diodes.

Additionally, the display may comprise a first plurality of light emitting diodes and the logic may be further configured to activate the infrared radiation emitting diodes during periods of time when the first plurality of light emitting diodes are not activated.

Additionally, the logic may be configured to time multiplex the activating of the infrared radiation emitting diodes with the activating the first plurality of light emitting diodes so that the infrared radiation emitting diodes and the first plurality of light emitting diodes do not emit electromagnetic radiation at the same time.

Additionally, the display may comprise a liquid crystal display, the liquid crystal display including a guide configured to guide electromagnetic radiation from the at least one electromagnetic radiation source up through the upper surface of the liquid crystal display.

Additionally, the logic may be further configured to receive a current or voltage associated with the contact and determine that the contact occurred when the current or voltage meets a threshold.

Additionally, the logic may be further configured to detect multiple touches on the display that occur simultaneously or substantially simultaneously based on received touch indications from at least two of the plurality of sensors.

Additionally, the plurality of sensors may be configured to detect electromagnetic radiation having a wavelength in the infrared range and not detect electromagnetic radiation having a wavelength in the visible light range.

Additionally, the at least one electromagnetic radiation source may comprise a plurality of electromagnetic radiation sources and the device may further comprise shielding disposed between at least some of the plurality of sensors and some of the plurality of electromagnetic radiation sources, the shielding preventing electromagnetic radiation emitted from the electromagnetic radiation sources from being directly received by the sensors.

Additionally, the display may comprise an organic light emitting diode based display or polymer light emitting diode based display.

Additionally, the device may comprise a mobile telephone.

According to another aspect, in a device comprising a display, a method is provided. The method includes activating at least one electromagnetic radiation source configured to emit electromagnetic radiation not visible to a user through an upper surface of the display and detecting electromagnetic radiation reflected from the user's finger or a stylus contacting the upper surface of the display. The method also includes determining that a contact with the display occurred based on the detected electromagnetic radiation and processing the contact.

Additionally, the method may comprise determining a location on the display or a display element associated with the contact and processing the contact based on the location or display element.

Additionally, the activating at least one electromagnetic radiation source may comprise activating a plurality of infrared radiation emitting diodes during periods of time when a plurality of visible light sources associated with the display are not activated.

Additionally, the display may comprise a liquid crystal display and the method may further comprise directing infrared radiation from the at least one electromagnetic radiation source up through an upper surface of the liquid crystal display using a guide.

Additionally, the determining that a contact occurred may comprise generating a current or voltage associated with the detected electromagnetic radiation and determining that the contact occurred when the current or voltage meets a threshold.

Additionally, the detecting electromagnetic radiation may comprise detecting electromagnetic radiation having a wavelength in the infrared range and not detecting electromagnetic radiation having a wavelength in the visible light range.

According to still another aspect, a device comprises display means comprising a first plurality of light emitting components that emit visible light and a second plurality of electromagnetic radiation emitting components that emit electromagnetic radiation that is not visible to a user. The device also comprises control means for activating at least some of the first plurality of light emitting components to provide visual output on the display means and for activating at least some of the second plurality of electromagnetic radiation emitting components. The device further comprises detection means for detecting electromagnetic radiation emitted from the at least some of the second plurality of electromagnetic radiation emitting components and reflected off of the user's finger or stylus contacting an upper surface of the display means and input detection means for detecting an input on the display means based on the detected electromagnetic radiation.

Additionally, the control means may be configured to activate the at least some of the second plurality of electromagnetic radiation emitting components when the first plurality of light emitting components are not activated.

### BRIEF DESCRIPTION OF THE DRAWINGS

Reference is made to the attached drawings, wherein elements having the same reference number designation may represent like elements throughout.

FIG. 1 is a diagram of an exemplary mobile terminal in which methods and systems described herein may be implemented;

FIG. 2 is a diagram illustrating components of the mobile terminal of FIG. 1 according to an exemplary implementation;

FIG. 3 illustrates components of the mobile terminal of FIG. 2 according to an exemplary implementation;

FIG. 4 is a diagram illustrating a portion of the display of FIG. 3 according to an exemplary implementation;

FIG. 5 schematically illustrates a portion of the display of FIG. 1 according to an exemplary implementation;

FIG. 6 is a flow diagram illustrating processing by a mobile terminal according to an exemplary implementation;

FIG. 7 is a diagram schematically illustrating a touch on the display of FIG. 5 according to an exemplary implementation; and

FIG. 8 is a diagram illustrating a portion of the display of FIG. 3 according to another exemplary implementation.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

Exemplary implementations of the invention will be described in the context of a mobile communication device. It should be understood that a mobile communication device is an example of a device that can employ a display consistent with the principles described herein and should not be construed as limiting the types or sizes of devices or applications that include displays described herein. For example, displays consistent with the principles described herein may be used on a desktop device (e.g., a personal computer or workstation), a laptop computer, a personal digital assistant (PDA), a media playing device (e.g., an MPEG audio layer 3 (MP3) player, a digital video disc (DVD) player, a video game playing device), a household appliance (e.g., a microwave oven and/or appliance remote control), an automobile radio faceplate, a television, a computer screen, an industrial device (e.g., test equipment, control equipment) or any other device that includes a display.

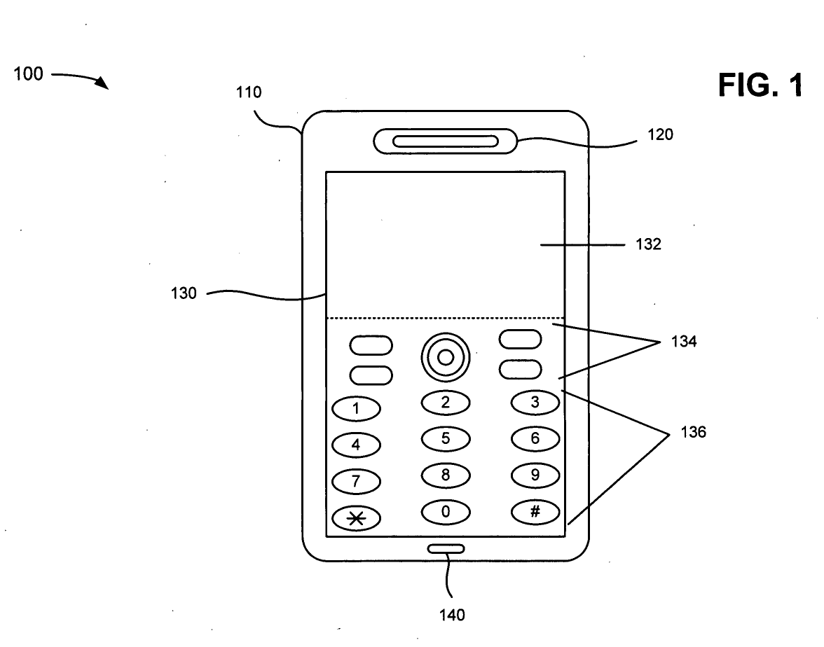

FIG. 1 is a diagram of an exemplary mobile terminal 100 in which methods and systems described herein may be implemented. As used herein, the term “mobile terminal” may include a cellular radiotelephone with or without a multi-line display; a Personal Communications System (PCS) terminal that may combine a cellular radiotelephone with data processing, facsimile and data communications capabilities; a PDA that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices. Mobile terminal 100 may also include media playing capability. As described above, it should also be understood that systems and methods described herein may also be implemented in other devices that include displays, with or without including various other communication functionality.

Referring to FIG. 1, mobile terminal 100 may include a housing 110, a speaker 120, a display 130 and a microphone 140. Housing 110 may protect the components of mobile terminal 100 from outside elements. Speaker 120 may provide audible information to a user of mobile terminal 100. Microphone 140 may receive audible information from the user.

Display 130 may include an upper display area 132 (referred to herein as upper display 132) that provides visual information to the user. For example, upper display 132 may include the area located above the dotted line shown in FIG. 1 and may provide information regarding incoming or outgoing telephone calls and/or incoming or outgoing electronic mail (e-mail), instant messages, short message service (SMS) messages, etc. Upper display 132 may also display information regarding various applications, such as a phone book/contact list stored in mobile terminal 100, a telephone number, the current time, video games being played by a user, downloaded content (e.g., news or other information), etc.

Control buttons 134 may permit the user to interact with mobile terminal 100 to cause mobile terminal 100 to perform one or more operations, such as place a telephone call, play various media, etc. For example, control buttons 134 may include a dial button, hang up button, play button, etc. Keypad 136 may include a telephone keypad used to input information in mobile terminal 100.

In an exemplary implementation, display 130 may operate as both an output device used to display information to a user and as a touch screen input device used to receive input from the user. In one implementation, display 130 may include a light emitting diode (LED) based display, such as an organic LED (OLED) based display, a polymer LED (poly-LED) based display or another type of LED display. In an exemplary implementation, one or more light sources, such as an infrared (IR) LED, may be included or integrated into the active display, such as an active matrix OLED (AMOLED) display. In another implementation, display 130 may be a liquid crystal display (LCD), such as a thin film transistor LCD display. In this case, one or more IR radiation emitting sources, such as diodes emitting IR radiation (also referred to herein as IR LEDs) may be used with the backlight LEDs to provide IR rays over all or a portion of display 130. In each case, the IR LEDs may emit electromagnetic radiation that is not visible to the human eye (e.g., sub-visible electromagnetic radiation) and does not affect the information and/or visual elements being provided via display 130. When a user touches a portion of display 130, rays from one or more of the IR LEDs will be reflected back and sensed by a detector to enable display 130 to operate as a touch screen display. In this manner, display 130 may function as a touch screen display that is not dependent on the content of display 130. That is, a separate electromagnetic radiation source (e.g., an IR source) that is not associated with the visual elements provided on display 130 will be the source of electromagnetic radiation received at the sensors, as opposed to light associated with the visual elements provide on display 130.

In an exemplary implementation, control buttons 134 and keypad 136 may be part of display 130. That is, upper display 132, control buttons 134 and keypad 136 may be provided via an LED-based or LCD-based display that also operates as a touch screen display. In this case, IR LEDs may be integrated into the display to allow portions of display 132, control buttons 134 and keypad 136 to function as a touch screen display.

In other implementations, control buttons 134 and keypad 136 may operate as both an output device to display information and a touch screen display and display area 132 may act as only an output display without touch screen functionality. For example, control buttons 134 and/or keypad 136 may include IR LEDs that emit IR rays, which when reflected back by a user's finger or stylus contacting one or more of control buttons 134 are detected by sensors that register an input. In still other implementations, a limited number of touch-sensitive areas may be located on the periphery of display area 132 or within display area 132 to provide touch screen functionality in those particular areas.

In some implementations, different control buttons and keypad elements may be provided based on the particular mode in which mobile terminal 100 is operating. For example, when operating in a cell phone mode, a conventional telephone keypad may be displayed in area 136 and control buttons associated with dialing, hanging up, etc. may be displayed in area 134. When operating as a music playing device, keypad elements and control buttons associated with playing music may be displayed in areas 134 and 136. In some implementations, the touch screen functionality may be dependent on the particular mode in which mobile terminal 100 is operating. For example, when operating in a cell phone mode, mobile terminal 100 may operate in a touch screen mode and when operating in a game playing mode, mobile terminal 100 may not operate in a touch screen mode, or vice versa. In such implementations, control buttons 134 may include one or more buttons that controls various settings associated with display 130. For example, one of control buttons 134 may be used to toggle between operating upper display 132 as a conventional display (e.g., without touch screen capability) and operating upper display 132 as a touch screen display. Further, one of control buttons 134 may be a menu button that permits the user to view various settings associated with mobile terminal 100. Using the menu, a user may also be able to toggle upper display 132 between a conventional display and a touch screen display.

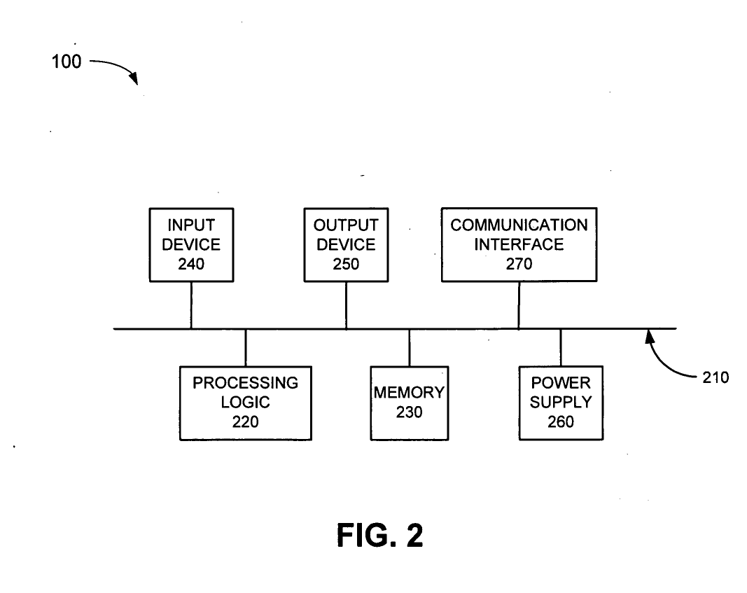

FIG. 2 is a diagram illustrating components of mobile terminal 100 according to an exemplary implementation. Mobile terminal 100 may include bus 210, processing logic 220, memory 230, input device 240, output device 250, power supply 260 and communication interface 270. Bus 210 permits communication among the components of mobile terminal 100. One skilled in the art would recognize that mobile terminal 100 may be configured in a number of other ways and may include other or different elements. For example, mobile terminal 100 may include one or more modulators, demodulators, encoders, decoders, etc., for processing data.

Processing logic 220 may include a processor, microprocessor, an application specific integrated circuit (ASIC), field programmable gate array (FPGA) or the like. Processing logic 220 may execute software instructions/programs or data structures to control operation of mobile terminal 100.

Memory 230 may include a random access memory (RAM) or another type of dynamic storage device that stores information and instructions for execution by processing logic 220; a read only memory (ROM) or another type of static storage device that stores static information and instructions for use by processing logic 220; a flash memory (e.g., an electrically erasable programmable read only memory (EEPROM)) device for storing information and instructions; and/or some other type of magnetic or optical recording medium and its corresponding drive. Memory 230 may also be used to store temporary variables or other intermediate information during execution of instructions by processing logic 220. Instructions used by processing logic 220 may also, or alternatively, be stored in another type of computer-readable medium accessible by processing logic 220. A computer-readable medium may include one or more memory devices and/or carrier waves.

Input device 240 may include mechanisms that permit an operator to input information to mobile terminal 100, such as display 130, microphone 140, a keyboard, a mouse, a pen, voice recognition and/or biometric mechanisms, etc. For example, as discussed above, all or a portion of display 130 may function as a touch screen input device for inputting information to mobile terminal 100.

Output device 250 may include one or more mechanisms that output information to the user, including a display, such as display 130, a printer, one or more speakers, such as speaker 120, etc. Power supply 260 may include one or more batteries or other power source components used to supply power to components of mobile terminal 100. Power supply 260 may also include control logic to control application of power from power supply 260 to one or more components of mobile terminal 100.

Communication interface 270 may include any transceiver-like mechanism that enables mobile terminal 100 to communicate with other devices and/or systems. For example, communication interface 270 may include a modem or an Ethernet interface to a LAN. Communication interface 270 may also include mechanisms for communicating via a network, such as a wireless network. For example, communication interface 270 may include one or more radio frequency (RF) transmitters, receivers and/or transceivers. Communication interface 270 may also include one or more antennas for transmitting and receiving RF data.

Mobile terminal 100 may provide a platform for a user to make and receive telephone calls, send and receive electronic mail, text messages, play various media, such as music files, video files, multi-media files, games, and execute various other applications. Mobile terminal 100 may also perform processing associated with display 130 operating as a touch screen input device. Mobile terminal 100 may perform these operations in response to processing logic 220 executing sequences of instructions contained in a computer-readable medium, such as memory 230. Such instructions may be read into memory 230 from another computer-readable medium via, for example, communication interface 270. A computer-readable medium may include one or more memory devices and/or carrier waves. In alternative embodiments, hard-wired circuitry may be used in place of or in combination with software instructions to implement processes consistent with the invention. Thus, implementations described herein are not limited to any specific combination of hardware circuitry and software.

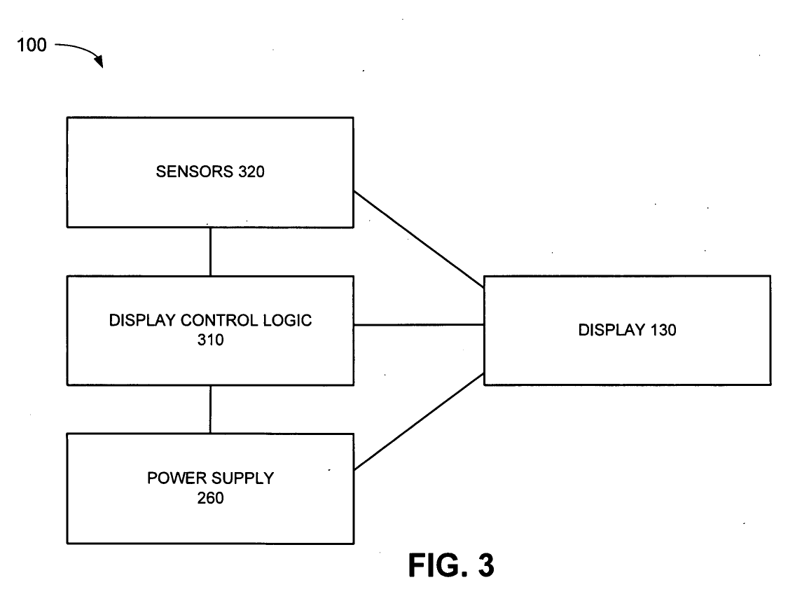

FIG. 3 is a functional diagram of components implemented in mobile terminal 100. Referring to FIG. 3, mobile terminal 100 may include display control logic 310, sensors 320, power supply 260 and display 130. Display control logic 310 may be included in processing logic 220 and sensors 320 may be included in input device 240.

In an exemplary implementation in which display 130 is an LED based display, such as an OLED based display, display control logic 310 may provide power or signal power supply 260 to activate LEDs of display 130 to allow display 130 to operate as an emissive display and a touch sensitive display. For example, in one implementation, display control logic 310 may forward bias one or more LEDs of display 130 so that the LEDs emit visible light associated with display 130 and to also forward bias one or more IR LEDs of display 130 so that the IR LEDs emit electromagnetic waves that are not visible to the human eye. These IR LEDs may work in conjunction with sensors 320 that are able to detect rays from the IR LEDs that is reflected from a user's finger or stylus contacting the upper surface of display 130. In this manner, display 130 is able to operate as an output or display device and to also operate as an input or touch sensitive display device, as described in detail below.

Sensors 320 may include any sensor that is able to receive electromagnetic radiation and generate a signal indicating that electromagnetic radiation has been detected or that electromagnetic radiation meeting a predetermined threshold has been detected. In one implementation, sensors 320 may include photosensors or photodiodes that convert received IR radiation into a signal based on the strength of the received IR radiation. Sensors 320 may provide the signal indicating that IR radiation has been detected and/or a value indicating the strength of the detected IR radiation to display control logic 310. Display control logic 310 may then determine whether an input has been detected, as described in more detail below.

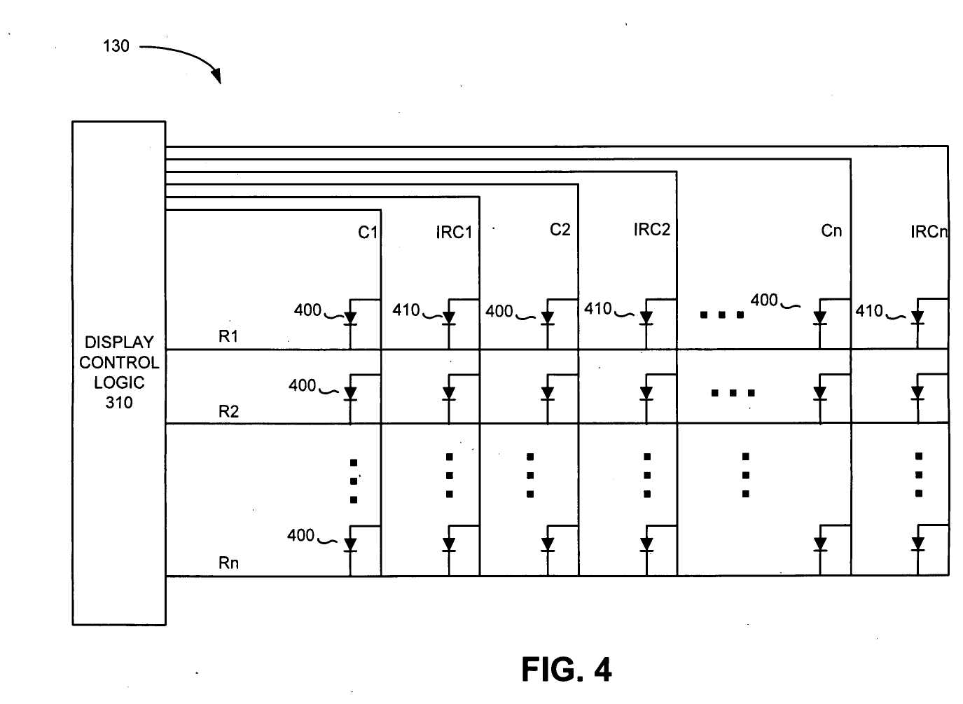

In an exemplary implementation, display 130 may include a number of LEDs organized, for example, in a matrix of rows and columns. For example, referring to FIG. 4, display 130 may include a number of LEDs 400 arranged in rows R1-Rn and columns C1-Cn. Display control logic 310 may provide power to LEDs 400 on a row-by-row basis or column-by-column basis using row drivers and/or column drivers (not shown in FIG. 4 for simplicity). Other configurations of LEDs may also be used.

An individual pixel of display 130 can be illuminated by applying a positive voltage to one or more columns of LEDs corresponding to the pixel and grounding the row associated with the one or more LED(s). In addition, to provide visual elements on display 130, the LEDs in various columns that will be used to display information may be biased with a positive voltage for a predetermined duration or frame time, while the row is grounded. Display control logic 310 may then perform the same procedure for the next row of the display (e.g., ground the row and positively bias the appropriate columns) and continue this procedure for each row. When the last row is reached, display control logic 310 returns to the first row of display 130 and continues the process. Performing this row-by-row process quickly enough provides a display that appears steady to the human eye.

In an exemplary implementation, display 130 may be a color display, such as a red, green, blue (RGB) display. In this implementation, three diodes 400 may form a single pixel of display 130. For example, a red diode, a green diode and a blue diode that emit red, green and blue light, respectively, when the diode is forward biased with a predetermined voltage may be combined to display a single pixel of information on display 130. The individual diodes 400 may also be referred to herein as sub-pixels.

Display 130 may also include IR LEDs 410 that are integrated into display 130, as illustrated in FIG. 4. IR LEDs 410 may work in conjunction with sensors 320 (not shown in FIG. 4 for simplicity) to provide touch screen functionality, as described in detail below. In an exemplary implementation, LEDs 410 may be diodes that emit electromagnetic radiation that is not visible to the human eye, such as electromagnetic radiation having a wavelength in the infrared (IR) region (e.g., 10⁻⁴ to 10⁻⁶ meter range), and therefore, do not affect what is visually provided to the user on display 130. In addition, LEDs 410 (also referred to herein as IR LEDs 410) may be organized into rows and columns in a manner similar to LEDs 400. For example, referring to FIG. 4, display 130 may include a number of LEDs 410 arranged in rows R1-Rn and columns IRC1-IRCn. Display control logic 310 may activate or provide power to rows of LEDs 410 on a row-by-row basis or column-by-column basis using row drivers and/or column drivers (not shown in FIG. 4 for simplicity). Other configurations of LEDs 410 may also be used.

In an exemplary implementation, IR LEDs 410 may correspond to one or more of LEDs 400. For example, each pixel in display 130 may have a corresponding IR LED 410 that enables all or most of the surface of display 130 to function as a touch screen. In other implementations, an IR LED 410 may be provided for each area in which touch functionality is desired. In each case, when a user's finger or stylus nears or touches the upper surface of display 130, rays from one or more of IR LEDs 410 is reflected from the user's finger or stylus. Some of the reflected light may be detected by one or more of sensors 320. Display control logic 310 may receive information, such as an indication signal or an electrical current or voltage, indicating that a particular sensor 320 detected IR radiation. This information may then be correlated to a signal indicating that a user pressed or touched a particular portion of display 130 (i.e., intended to enter an input). In some implementations, the electrical current (or voltage) needed to generate a signal indicating that an input/contact was detected may be set to a predetermined threshold to reduce or eliminate false or incidental touches, as described in detail below.

Sensors 320, as described above, may be configured to detect any electromagnetic radiation. As a result, sensors 320 may detect light reflected from LEDs 400, as well as IR radiation from LEDs 410 (e.g., IR radiation reflected off of a user's finger touching the surface of display 130). To avoid light from LEDs 400 from affecting sensors 320, sensors 320 and IR LEDs 410 may be synchronized or gated such that sensors 320 are only active to detect radiation when IR LEDs 410 are active. In other implementations, sensors 320 may be configured to detect only light in the IR range (e.g., 10⁻⁴ to 10⁻⁶ meters), as described in more detail below.

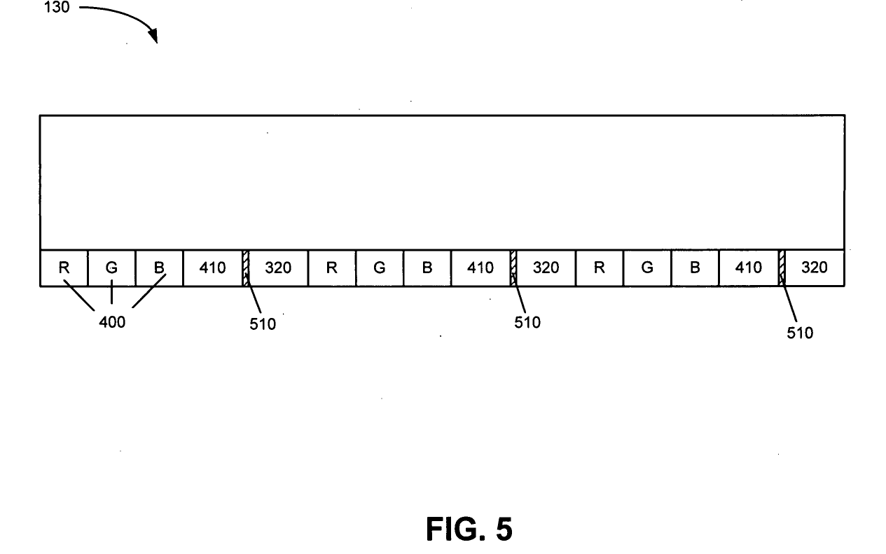

FIG. 5 schematically illustrates a portion of display 130 according to an exemplary implementation. Referring to FIG. 5, display 130 may include red, green and blue diodes/sub-pixels (labeled R, G and B, respectively) associated with an RGB display. Each R, G, B sub-pixel may correspond to one of LEDs 400. An IR LED 410 may be located adjacent each set of RGB sub-pixels 400, as illustrated in FIG. 5. Alternatively, one or more IR LEDs 410 may be located for each region/area in which touch functionality is desired. A sensor 320 may be located adjacent each IR LED 410, as illustrated in FIG. 5, to detect electromagnetic radiation from IR LED 410 that is reflected off of a user's finger or stylus contacting the upper surface of display 130. The detected electromagnetic radiation may then be correlated to a touch on a particular portion of display 130.

In an exemplary implementation, shielding may be used to shield or inhibit electromagnetic radiation from one of IR LEDs 410 from passing directly to sensor 320 and being detected by sensor 320, as opposed to detecting electromagnetic radiation reflected from a user's finger or stylus. For example, referring to FIG. 5, rectangular or cylindrical structures 510 may be formed between IR LEDs 410 and sensors 320. IR rays from IR LED 410 will not penetrate shielding 510, thereby preventing sensor 320 from directly receiving electromagnetic radiation from IR LED 410 and incorrectly interpreting such electromagnetic radiation as an input/touch. However, electromagnetic radiation from IR diode 410 may be indirectly received by sensor 320 via a reflection from a user's finger or stylus, as described in more detail below, and properly correlated to a touch or input on display 130. Although shielding 510 is illustrated as being formed between LEDs 410 and sensors 320, in some implementations, LEDs 400 may include optical shielding between adjacent diodes and/or sensors 320.

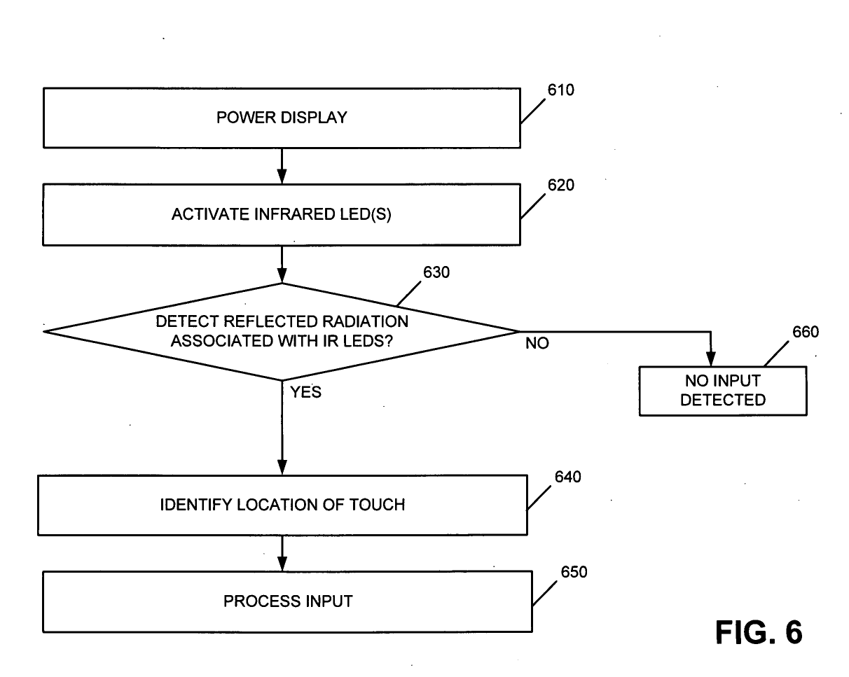

FIG. 6 is a flow diagram illustrating processing by mobile terminal 100 in an exemplary implementation. Processing may begin when mobile terminal 100 powers up. Display control logic 310 may provide power to display 130 (act 610). As discussed above with respect to FIG. 4, display control logic 310 may activate or power (e.g., forward bias) various LEDs 400 (or columns of LEDs) to emit light visible to the user. For example, if display 130 is being used to display various visual elements, the appropriate columns of LEDs 400 corresponding to these visual elements may be driven with a supply voltage on a row-by-row basis.

Display control logic 310 may also activate (e.g., forward bias) some of IR LEDs 410 to emit IR radiation (act 620). In an exemplary implementation, to avoid light from LEDs 400 from interfering with sensors 320 (e.g., light from LEDs 400 being reflected by a user's finger of stylus and being incorrectly interpreted as a touch), display control logic 310 may time multiplex the activation (e.g., forward biasing) of LEDs 400 with the activation of IR LEDs 410 so that the light from LEDs 400 will not be detected by sensors 320 and interpreted as a touch indication. In this case, a sensor 320 may be synchronized with one or more IR LEDs 410 to operate to detect electromagnetic radiation only when the corresponding IR LED 410 is activated and emitting electromagnetic radiation.

In an exemplary implementation, display control logic 310 may activate or power the appropriate row/column of LEDs 400 followed by the activating or powering of a corresponding row/column of IR LEDs 410. For example, display control logic 310 may forward bias the red, green and blue diodes 400 corresponding to a pixel on display 130 when visual information is to be presented for that pixel. Display control logic 310 may forward bias these red, green and blue diodes for a frame time, followed by forwarding biasing one or more IR LEDs 410 for a succeeding frame in which the corresponding red and blue diodes 400 associated with the pixel are no longer powered (act 620).

For example, suppose that red, green and blue diodes 400 in row 2, columns 1-3, respectively, correspond to a single pixel of display 130. In this case, when that single pixel is to display information, display control logic 310 may forward bias the red, green and blue sub-pixels in row 2, columns 1-3 for a time T₁. After time T₁, display control logic 310 may forward bias an LED 410 corresponding to the red, green and blue sub-pixels for another duration of time, such as time T₂. The particular duration of time T₁ during which the red, green and blue diodes 400 are activated and time T₂ during which IR LEDs 410 are activated may vary. For example, in some implementations, the IR LEDs 410 may be activated for a shorter duration than the period during which LEDs 400 are activated (i.e., T₁ may be greater than T₂). In other instances T₁ and T₂ may be equal. In each case, the duration of time T₂ may be small enough so that the user does not perceive any flickering of the image displayed on display 130.

Sensors 320, as discussed above, may be synchronized or electrically gated with one or more IR LEDs 410 to operate to detect electromagnetic radiation only when the IR LED(s) 410 is activated/powered. Sensors 320 may then determine whether electromagnetic radiation is detected (act 630). For example, as described previously, sensors 320 may include sensors that are configured to detect electromagnetic radiation and output a signal when electromagnetic radiation is detected. Alternatively, sensors 320 may be photo-sensors (e.g., photo-diodes) that convert received electromagnetic radiation into a current or voltage. That is, when sensor 320 is activated, if electromagnetic radiation is reflected back and falls incident upon sensor 320, the electromagnetic radiation may be detected by the sensor 320 and converted into a current (or voltage) by the sensor 320.

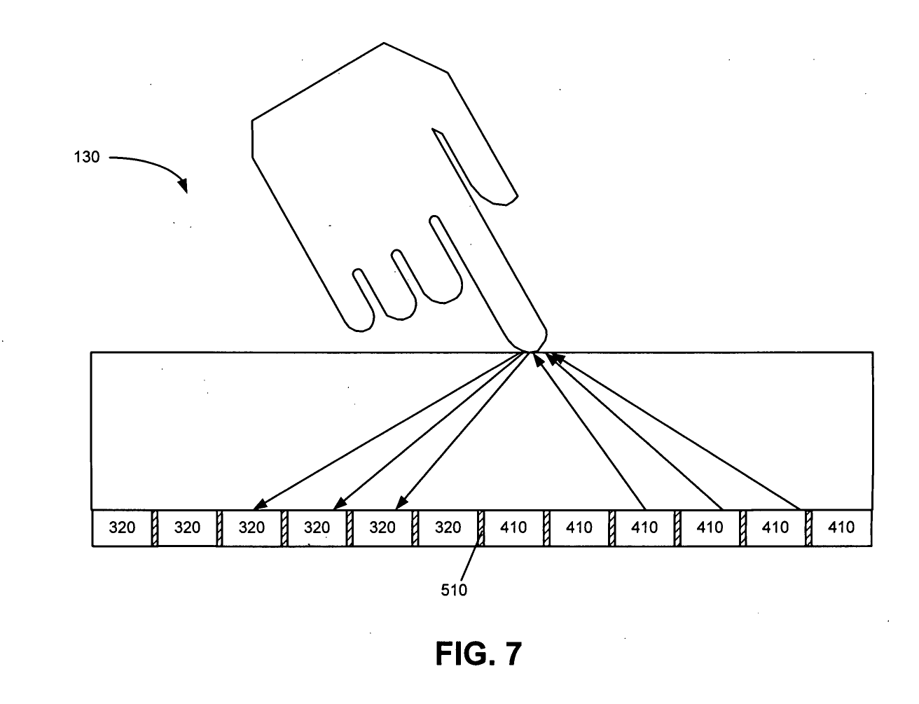

As an example, suppose that the user of mobile terminal 100 would like to enter a telephone number via keypad 136 of display 130. Further assume that the user touches a number on keypad 136, as illustrated in FIG. 7. In FIG. 7, only IR LEDs 410 and sensors 320 are illustrated for simplicity. Electromagnetic radiation emitted from one of more of the IR LEDs 410 may be reflected by the user's finger back to one or more of sensors 320, as illustrated in FIG. 7. These sensors 320 may then detect the reflected electromagnetic radiation and signal display control logic 310 that electromagnetic radiation has been detected. Display control logic 310 may receive the signal (or a current/voltage) from the sensors 320.

If display control logic 310 receives a signal from sensor 320, display control logic 310 may then identify the location of the touch/input based on the particular sensor(s) 320 associated with the received indication (act 640). For example, display control logic 310 may determine the row/column associated with the sensor 320 and corresponding IR LED(s) 410 that produced the indication/current. By gating sensors 320 with IR LEDs 410, display control logic 310 can determine the row/column associated with the contact. Display control logic 310 may then determine that the user intended to provide an input via a particular visual element (e.g., a number on keypad 136, one of control buttons 134, etc.). Display control logic 310 may then process the input (act 650). For example, assume that the detected touch corresponded to a location in an area where the number 4 was displayed on keypad 136. In this case, display control logic 310 may display the number 4 in upper display 132.

As discussed above, in some implementation, when sensors 320 include photo-sensors that generate an output voltage or current based on the intensity of detected electromagnetic radiation, display control logic 310 may determine whether the current (or voltage) meets a predetermined threshold. This threshold may be used to avoid false touch indications associated with incident electromagnetic radiation that may be received by sensors 320. That is, some incident electromagnetic radiation may fall upon sensors 320 and produce a small current. For example, prior to a finger or stylus (or some other object) actually contacting display 130, electromagnetic radiation may be reflected from the user's finger, stylus or other object located over display 130. The amount of electromagnetic radiation reflected back, however, may be scattered and only a small portion may fall on sensors 320. In this case, the resulting current or voltage generated by the sensors 320 receiving the incident electromagnetic radiation may be relatively small. If the current is less than a threshold, this may indicate that current is not associated with a touch on display 130.

If no current is detected by display control logic 310 at act 630 (or the current is less than a predetermined threshold), no input is detected (act 660) and display control logic 310 may continue to activate the various diodes 400 of display 130 based on the visual elements that are to be displayed and also activate IR LEDs 410 in a time multiplexed manner with respect to LEDs 400. As discussed previously, time multiplexing the activation of LEDs 400 and IR LEDs 410 so that the durations during which LEDs 400 are not activated is very short will result in no discernible change (e.g., flicker) in visual elements output via display 130.

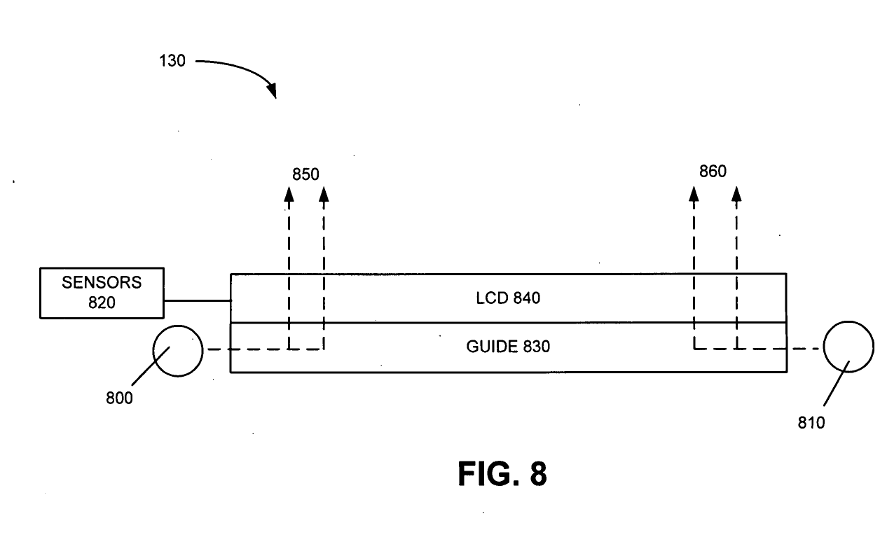

As described above, display 130 may include an LED based display, such as an AMOLED display, which includes IR LEDs 410 integrated within the active display. In another implementation, display 130 may be an LCD type display in which one or more IR LEDs are included with the conventional back lighting LEDs. For example, FIG. 8 schematically illustrates a portion of display 130 according to another exemplary implementation. Referring to FIG. 8, display 130 may include light source 800, electromagnetic radiation source 810, sensors 820, guide 830 and LCD 840. Light source 800 may be a conventional light source, such as an LED similar to LED 400 described above, a fluorescent light source, incandescent light source, etc. Electromagnetic radiation source 810 may be a source that emits electromagnetic radiation not visible to the human eye. In one implementation, electromagnetic radiation source 810 may be an IR LED similar to IR LEDs 410 described above. Only one light source 800 and one electromagnetic radiation source 810 are shown for simplicity. It should be understood that light source 800 and electromagnetic radiation source 810 may each include a number of individual electromagnetic radiation sources, such as a number of LEDs.

Sensors 820 may include any sensor that is able to receive electromagnetic radiation and generate a signal indicating that electromagnetic radiation has been detected or that electromagnetic radiation meeting a predetermined threshold has been detected. For example, sensors 820 may include sensors similar to sensors 320 described above. Guide 830 may be a conventional light guide that directs light from a light source, such as light source 800, and electromagnetic radiation from electromagnetic radiation source 810 up through LCD 840. LCD 840 may be any type of liquid crystal display, such as a thin film transistor based LCD display, or other display used to display information to a user. Other devices may be included in display 130, such as one or more reflecting films (not shown in FIG. 8) that may be used to reflect ambient light up through LCD 840 during high level ambient light conditions. During low or normal level light conditions, light from light source 800 may be directed through guide 830 and pass through LCD 840 (and any reflecting film), as illustrated by dashed lines 850 in FIG. 8.

In this implementation, electromagnetic radiation source 810 may emit IR rays that are dispersed by guide 830 up through any reflecting films and LCD 840, as illustrated by dashed lines 860 in FIG. 8. Similar to the discussion above with respect to FIG. 6, light source 800 and electromagnetic radiation source 810 may be time multiplexed such that electromagnetic radiation source 810 is only activated when light source 800 is not activated. Pulsing electromagnetic radiation source 810 for short durations of time will not result in any discernible effect on the user (e.g., the user will not perceive any flicker in display 130).

Sensors 820 may be coupled to portions of LCD 840 or integrated within LCD 840. In each case, sensors 820 may be arranged to receive electromagnetic radiation reflected from a user's finger or stylus in a similar manner to sensors 320 described above with respect to FIG. 7. Sensors 820 may also be electrically gate with electromagnetic radiation source 810 such that sensors 820 are only activated when electromagnetic radiation source 810 is activated.

In this manner, one or more IR light sources 810 may be used to emit electromagnetic radiation through LCD 840 that may be reflected by a user's finger or stylus and detected by sensors 820. Display control logic 310 (not shown in FIG. 8) may then receive information indicating that electromagnetic radiation was detected by one or more of sensors 820 and determine a location of the touch/input. For example, display control logic 310 may identify a particular sensor 820 that provided the touch indication and correlate this sensor to a visual element being displayed on display 130 and/or a location (e.g., x and y coordinates) on display 130. Display control logic 310 may then process the input in a manner similar to that described above in FIG. 6.

Display control logic 310 may continue to operate to detect the user's inputs. In this manner, display 130 may act as a touch screen without providing additional elements/components on the surface of display 130. This prevents loss of front-of-screen performance and also allows display 130 to remain very thin.

Display control logic 310 may also be used to detect multiple touches at different locations on display 130 that occur simultaneously or substantially simultaneously. For example, if a user touches two of his/her fingers at the same time at different locations on display 130, electromagnetic radiation reflected from the users' fingers will be detected by different ones of the sensors 320 (or sensors 820). The sensors 320/820 that received the reflected light will then generate signals (or current/voltage values) based on the reflected electromagnetic radiation associated with the multiple touches. Display control logic 310 may then determine the locations or areas of the multiple touches on display 130 based on the addresses (e.g., row and column addresses) of the IR LEDs 410 and/or location associated with sensors 320 or 820 that detected the electromagnetic radiation. In this manner, a user may provide any number of touches simultaneously or substantially simultaneously and display control logic 310 will be able to detect and process the multiple touches/inputs.

As described above, light from visible light sources (e.g., light sources 400, 800) may be time multiplexed with IR radiation sources (e.g., sources 410, 810) to avoid light from the visible LEDs from being detected by the sensors (e.g., sensors 320 or 820). In other implementations, sensors 320 and 820 may be configured to detect electromagnetic radiation having particular wavelengths or ranges of wavelengths, such as IR wavelengths (e.g., 10⁻⁴ to 10⁻⁶ meters). In this implementation, the IR sources (e.g., sources 410 and 810) may be activated or powered concurrently with the visible light sources. In addition, sensors 320 and 820 may not be electrically gated with the IR light sources in these implementations.

### CONCLUSION

Implementations described herein provide a display which acts as a touch screen display that is not content dependent. For example, even when a display is displaying a dimly lit image, a dark image or a black screen (i.e., not actively displaying an image), IR sources may be used to enable a user's finger or stylus to produce adequate reflectance that may be detected by a sensor. The detected reflectance may then be registered an input. This also advantageously provides a power savings with respect to conventional displays since the display does not have to be lit at all times to provide touch screen functionality. In addition, touch screen functionality may be provided without additional components being provided on the front of the display. Advantageously, this may enable the display to provide good front-of-screen performance and remain very thin.

The foregoing description of the embodiments of the invention provides illustration and description, but is not intended to be exhaustive or to limit the invention to the precise form disclosed. Modifications and variations are possible in light of the above teachings or may be acquired from practice of the invention.

For example, aspects of the invention have been mainly described in the context of a mobile terminal. As discussed above, the invention may be used with any type of device that includes a display. In addition, aspects have been described with respect to a color display. In other implementations, a monochrome display may be used in a manner similar to that described above. Still further, various types of electromagnetic radiation sources have been described. It should be understood that these devices are exemplary only and other electromagnetic radiation sources which have the functionality described above may be used in alternative implementations.

Further, while a series of acts have been described with respect to FIG. 6, the order of the acts may be varied in other implementations consistent with the invention. Moreover, non-dependent acts may be performed in parallel.

It will also be apparent to one of ordinary skill in the art that aspects described herein may be implemented in methods and/or computer program products. Accordingly, aspects of the invention may be embodied in hardware and/or in software (including firmware, resident software, micro-code, etc.). Furthermore, aspects described herein may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain aspects described herein may be implemented as “logic” that performs one or more functions. This logic may include hardware, such as a processor, microprocessor, an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the invention is defined by the claims and their equivalents.

What is claimed is:

1. A device, comprising:
a display;
at least one electromagnetic radiation source configured to emit electromagnetic radiation that is not visible to a user through an upper surface of the display;
a plurality of sensors configured to detect at least a portion of the emitted electromagnetic radiation that is reflected from the user's finger or a stylus contacting the upper surface of the display; and
logic configured to:
receive an indication from at least one of the plurality of sensors that a contact was detected, and
process the contact.

2. The device of claim 1, wherein the logic is further configured to:
determine a location on the display or a display element associated with the contact, and
process the contact based on the location or display element.

3. The device of claim 1, wherein the at least one electromagnetic radiation source comprises a plurality of infrared radiation emitting diodes.

4. The device of claim 3, wherein the display comprises a first plurality of light emitting diodes, the logic being further configured to:
activate the infrared radiation emitting diodes during periods of time when the first plurality of light emitting diodes are not activated.

5. The device of claim 4, wherein the logic is configured to time multiplex the activating of the infrared radiation emitting diodes with the activating the first plurality of light emitting diodes so that the infrared radiation emitting diodes and the first plurality of light emitting diodes do not emit electromagnetic radiation at the same time.

6. The device of claim 1, wherein the display comprises a liquid crystal display, the liquid crystal display including a guide configured to guide electromagnetic radiation from the at least one electromagnetic radiation source up through the upper surface of the liquid crystal display.

7. The device of claim 1, wherein the logic is further configured to:
receive a current or voltage associated with the contact, and
determine that the contact occurred when the current or voltage meets a threshold.

8. The device of claim 1, wherein the logic is further configured to:
detect multiple touches on the display that occur simultaneously or substantially simultaneously based on received touch indications from at least two of the plurality of sensors.

9. The device of claim 1, wherein the plurality of sensors are configured to detect electromagnetic radiation having a wavelength in the infrared range and not detect electromagnetic radiation having a wavelength in the visible light range.

10. The device of claim 1, wherein the at least one electromagnetic radiation source comprises a plurality of electromagnetic radiation sources, the device further comprising:
shielding disposed between at least some of the plurality of sensors and some of the plurality of electromagnetic radiation sources, the shielding preventing electromagnetic radiation emitted from the electromagnetic radiation sources from being directly received by the sensors.

11. The device of claim 1, wherein the display comprises an organic light emitting diode based display or polymer light emitting diode based display.

12. The device of claim 1, wherein the device comprises a mobile telephone.

13. In a device comprising a display, a method comprising:
activating at least one electromagnetic radiation source configured to emit electromagnetic radiation not visible to a user through an upper surface of the display;
detecting electromagnetic radiation reflected from the user's finger or a stylus contacting the upper surface of the display;
determining that a contact with the display occurred based on the detected electromagnetic radiation; and
processing the contact.

14. The method of claim 13, further comprising:
determining a location on the display or a display element associated with the contact; and
processing the contact based on the location or display element.

15. The method of claim 13, wherein the activating at least one electromagnetic radiation source comprises:
activating a plurality of infrared radiation emitting diodes during periods of time when a plurality of visible light sources associated with the display are not activated.

16. The method of claim 13, wherein the display comprises a liquid crystal display, the method further comprising:
directing infrared radiation from the at least one electromagnetic radiation source up through an upper surface of the liquid crystal display using a guide.

17. The method of claim 13, wherein the determining that a contact occurred comprises:
generating a current or voltage associated with the detected electromagnetic radiation, and
determining that the contact occurred when the current or voltage meets a threshold.

18. The method of claim 13, wherein the detecting electromagnetic radiation comprises:
detecting electromagnetic radiation having a wavelength in the infrared range and not detecting electromagnetic radiation having a wavelength in the visible light range.

19. A device, comprising:
display means comprising a first plurality of light emitting components that emit visible light and a second plurality of electromagnetic radiation emitting components that emit electromagnetic radiation that is not visible to a user;
control means for activating at least some of the first plurality of light emitting components to provide visual output on the display means and for activating at least some of the second plurality of electromagnetic radiation emitting components;
detection means for detecting electromagnetic radiation emitted from the at least some of the second plurality of electromagnetic radiation emitting components and reflected off of the user's finger or stylus contacting an upper surface of the display means; and
input detection means for detecting an input on the display means based on the detected electromagnetic radiation.

20. The device of claim 19, wherein the control means is configured to activate the at least some of the second plurality of electromagnetic radiation emitting components when the first plurality of light emitting components are not activated.
